(19) United States
(12) Patent Application Publication
(10) Pub. No.: US 2023/0175933 A1
(43) Pub. Date: Jun. 8, 2023

(54) Microfluidic guillotine for splitting cellular structures

(71) Applicant: The Board of Trustees of the Leland Stanford Junior University, Stanford, CA (US)

(72) Inventors: Lucas R. Blauch, Mountain View, CA (US); Sindy K. Y. Tang, Stanford, CA (US)

(21) Appl. No.: 18/103,086

(22) Filed: Jan. 30, 2023

Related U.S. Application Data
(63) Continuation of application No. 16/425,796, filed on May 29, 2019.
(60) Provisional application No. 62/679,618, filed on Jun. 1, 2018.

(51) Int. Cl. G01N 1/18; B01L 3/00

(52) U.S. Cl. CPC G01N 1/18; B01L 3/502761; B01L 3/502715; B01L 2200/0605; B01L 2200/0647; B01L 2300/0864; B01L 2200/027

(57) ABSTRACT

Splitting of biological samples is provided by flowing the samples through a flow splitter where the sample strikes a stationary blade and is split into two pieces that end up in separate output channels. Samples can be single cells or multi-cellular samples. The split ratio of the pieces can be 50:50 or it can be other values as determined by design. To first order, the split ratio of the pieces is the same as the split ratio of the fluid flows in the output channels.

### CROSS REFERENCE TO RELATED APPLICATIONS

This application is a continuation of U.S. patent application Ser. No. 16/425,796, filed on May 29, 2019, and hereby incorporated by reference in its entirety.

application Ser. No. 16/425,796 claims the benefit of U.S. provisional patent application 62/679,618, filed on Jun. 1, 2018, and hereby incorporated by reference in its entirety.

### GOVERNMENT SPONSORSHIP

This invention was made with Government support under contracts 1548297 and 1517089 awarded by the National Science Foundation. The Government has certain rights in the invention.

### FIELD OF THE INVENTION

This invention relates to handling of biological samples.

### BACKGROUND

It is often desirable to controllably split biological samples. Applications include studies of wound repair in single cells, and patient-specific drug assays, e.g. for cancer chemotherapy. Existing methods for performing this task have various disadvantages. For example, the conventional approach of manually wounding single cells is time-consuming and produces inconsistent results. As another example, conventional mincing of a tumor biopsy is also time-consuming and inconsistent, and furthermore tends to require a large biopsy sample. Accordingly it would be an advance in the art to provide improved splitting of biological samples.

### SUMMARY

Improved splitting of biological samples is provided by flowing the samples through a flow splitter where the sample strikes a stationary blade and is split into two pieces that end up in separate output channels. Samples can be single cells or multi-cellular samples. The split ratio of the pieces can be 50:50 or it can be other values as determined by design. To first order, the split ratio of the pieces is the same as the split ratio of the fluid flows in the output channels.

### BRIEF DESCRIPTION OF THE DRAWINGS

FIGS. 1A-B show a first embodiment of the invention.

FIG. 1C shows a second embodiment of the invention.

FIGS. 1D-F show several variations of splitters according to principles of this work.

FIGS. 2A-C show splitting of single cells according to this work.

FIG. 2D is a comparison showing manually split single cells.

FIGS. 3A-C show two different cell splitting regimes as determined by fluid flow rate.

FIGS. 4A-B show a comparison of cell wounding in the two splitting regimes.

FIGS. 5A-B show the effect of encapsulation of the samples to provide self-cleaning of the blade in operation.

FIGS. 5C-D relate to an 8× parallel splitter to improve throughput.

FIG. 5E is a comparison of single channel splitting to 8× splitting.

FIGS. 6A-B show splitting regimes for splitting of a fluid drop in a flow splitter.

FIGS. 7A-B show cell wounding results from the two splitting regimes.

FIGS. 8A-C show several blade angles used in the experiments of section B.

FIG. 8D shows the effect of blade angle on cell extension length.

FIG. 8E shows the effect of blade angle on cell survival.

FIGS. 9A-B show two different Y-junction configurations.

FIGS. 10A-E show further exemplary Y-junction configurations.

FIG. 11 shows splitting of a multi-cell sample.

### DETAILED DESCRIPTION

Section A describes general principles relating to various embodiments of the invention. Section B is an exemplary experimental study of splitting single cells. The example of Section C relates to splitting multi-cell samples.

### A) General Principles

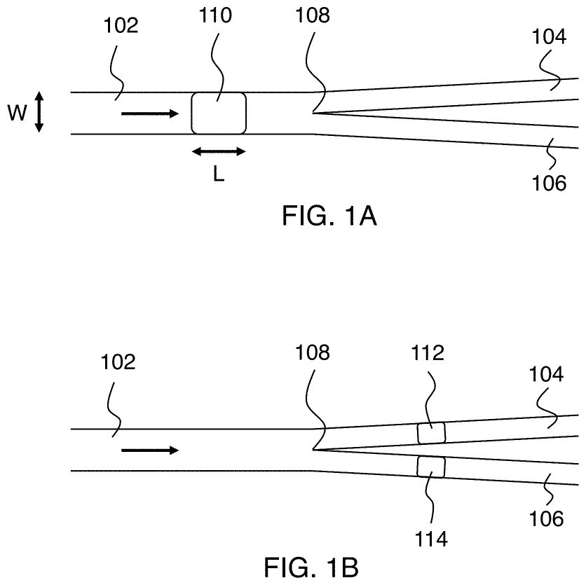

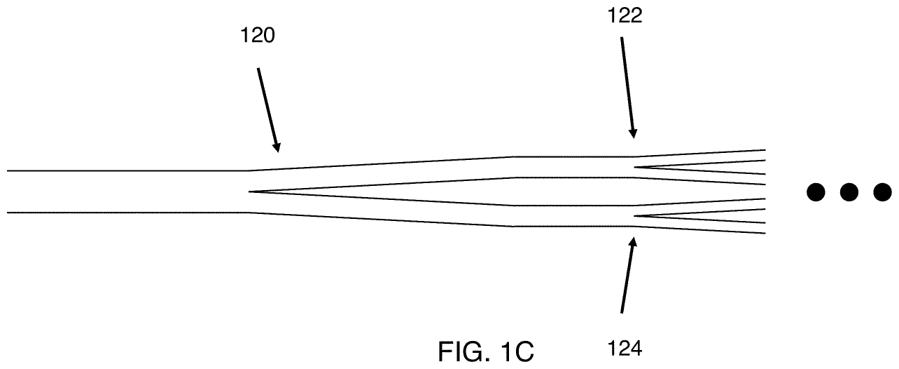

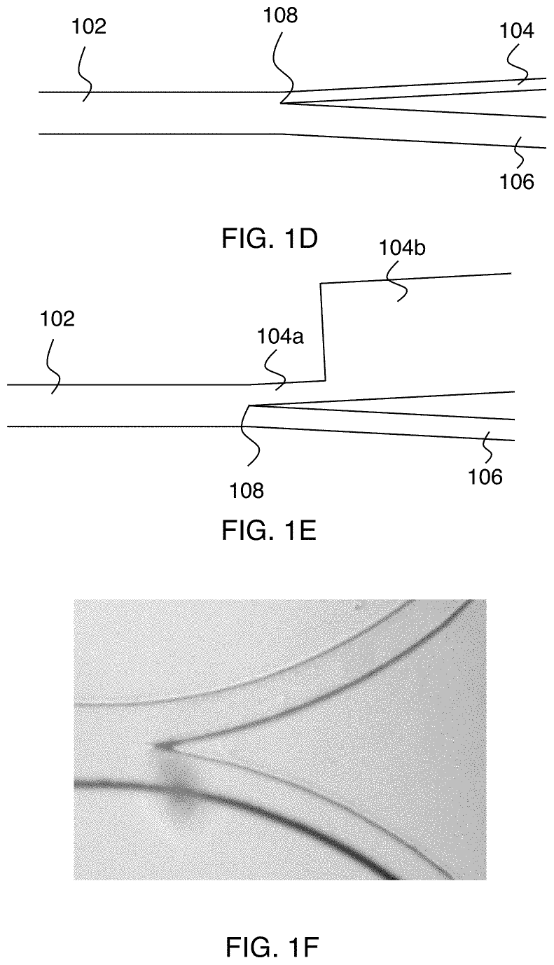

FIGS. 1A-B show operation of an exemplary embodiment of the invention. This example includes a fluidic inlet channel 102, and two fluidic outlet channels 104 and 106. The inlet channel and outlet channels meet at a Y-junction (as shown) where the inlet channel is in fluid communication with the two outlet channels. An interior tip 108 of the Y-junction is a blade configured to split a biological sample 110 from the fluidic inlet channel into substantially two parts (i.e., ‘primary parts’ as described below) while fluid flows through the apparatus, and to deliver the two primary parts 112 and 114 separately to the two fluidic outlet channels, as shown.

The biological sample can be a single cell or it can be a multi-cell sample. In many cases, splitting the sample in equal halves is preferred. Accounting for biological imprecision means this amounts to a preference for the outlet split ratio of the apparatus to be between 60:40 and 40:60. In general the biological sample will split into two primary parts plus, possibly, one or more small pieces of debris from the splitting. Here we define a successful splitting as the total debris volume being 10% or less of the input sample volume for single cell samples, and 20% or less of the input sample volume for multi-cell samples. Furthermore, the primary parts of the splitting are both larger than any piece of the debris. Regime I as described herein provides successful splitting as defined above, while regime II does not. In regime II, the result tends to be too much debris and poorly defined primary parts. Thus the notation for split ratios is X:Y where X and Y are the relative percentage sizes of the two primary parts that end up in each of the output channels. In other words, it is convenient to define split ratio as if no debris were generated by the splitting.

Preferably, as described in greater detail below, the flow rate of fluid through the apparatus is selected such that the biological sample is locally cut by the blade to provide the two parts (as opposed to the sample bursting or disintegrating at locations away from the blade). See the discussion of regimes I and II below. Briefly, in regime I, the sample is locally cut by the blade into the two primary parts, plus possibly a small amount of debris. In regime II, the sample bursts into the primary parts and debris at one or more locations away from the blade. Although the specific numbers to define these ranges will vary from sample from sample and from splitter to splitter, regime I is always at lower flow rates than regime II. Regime I consistently provides better splitting results, and is therefore preferred. As a practical matter, the lower limit of the regime I flow rate can be defined as the flow rate below which the biological sample is not split because the relevant forces are too low.

In cases where the blade has a simple triangular shape as shown, it is preferred for the angle of the blade to be 40 degrees or less. More preferably, this angle is as small an angle as possible. We found that smaller angles lead to higher cell survival and cleaner cuts with less cytoplasm spillage. The smallest angle we were able to fabricate with soft lithography was 6 degrees, but smaller angles will be possible with other methods. However, smaller angle blades will be less stiff than larger angle blades and could be deformed by a stiffer biological sample. This problem could be avoided by using a stiffer material for the blade, which would allow for smaller blade angles to be used without the blade deforming upon the biological sample hitting the blade. Other device parameters (e.g., wᵢ, w_{b}, wₒ, channel height, fluid viscosity, and the flow rates) can be determined empirically according to the present principles, and are expected to vary substantially according to details of the biological samples being cut. It is preferred for the mechanical stiffness (i.e., Young's modulus) of the blade material to be at least 10× the Young's modulus of the sample being cut.

An important function of the fluidic inlet channel is to provide a consistent positioning of the biological sample relative to the blade. The goal is to control a position of the biological sample while still permitting fluid flow and movement of the biological sample through the apparatus. The fluidic inlet channel is preferably sized such that the biological sample in the fluidic inlet channel forms a plug of length L in the fluidic inlet channel, where W is a largest lateral dimension of the fluidic inlet channel, and where L is 1.1 W or more, as schematically shown on FIG. 1A.

In some cases it is preferred for the fluidic outlet channels to expand in cross-section at the Y-junction such that a total width of the two fluidic outlet channels after this expansion is greater than or equal to a width of the fluidic inlet channel.

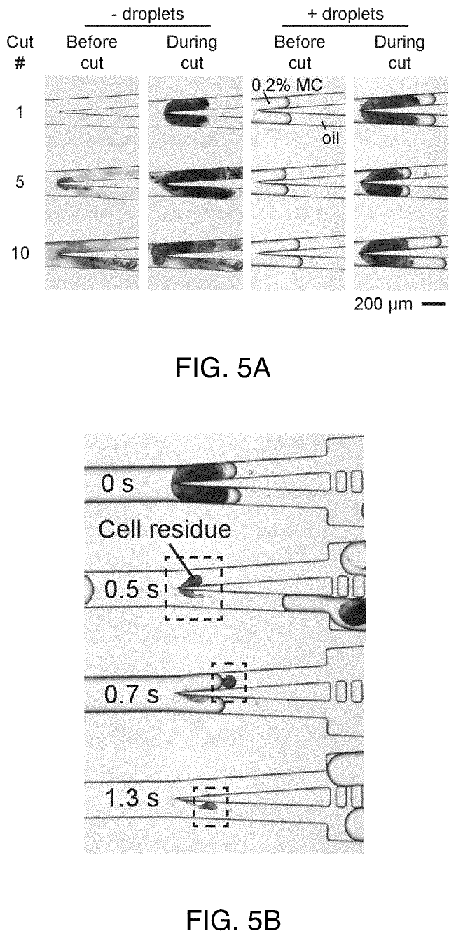

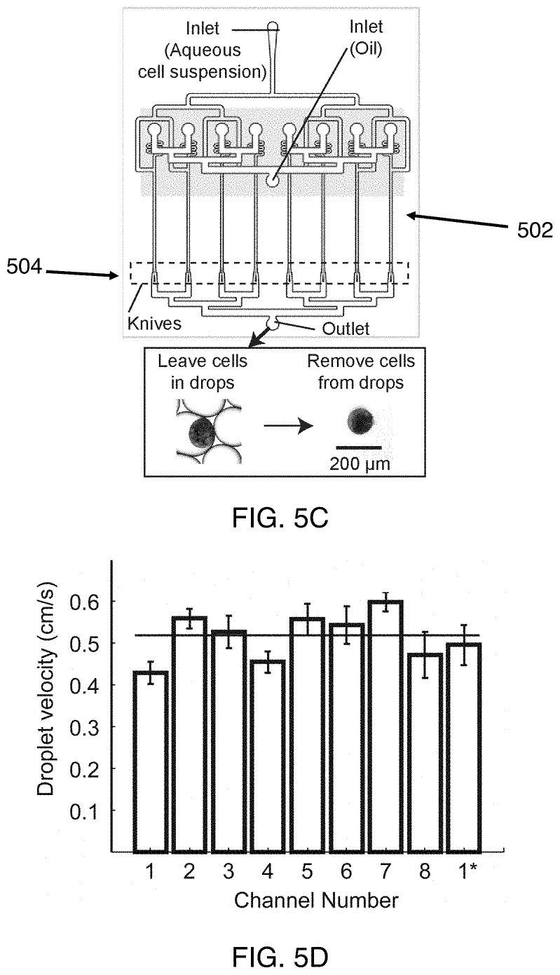

Some preferred embodiments further include a droplet dispenser configured to encapsulate the biological sample in a droplet to facilitate self-cleaning of the blade in operation. See the description relating to FIGS. 5A-E below.

The example of FIG. 1C is an apparatus for multiply dividing a biological sample. This apparatus includes two or more stages of splitters, where each outlet of a splitter of a prior stage is connected to an inlet of a splitter of a subsequent stage. In this example there are two stages: a first stage formed by splitter 120 and a second stage formed by splitters 122 and 124. Each splitter of each stage is a splitter as described above. Naturally, any number of stages can be employed. Apparatus as in FIG. 1C is expected to be particularly useful for providing a rapid and controlled splitting of a tumor biopsy into many consistently sized pieces. This capability can dramatically reduce the cost of patient-specific chemotherapy assays to determine which drugs and dosages work best for that specific patient and tumor.

Another approach for increasing splitting throughput is to run multiple splitters in parallel, as in the example of FIG. 5C described in detail below. Briefly, the apparatus includes a flow manifold 502 configured to provide a fluid flow including the biological sample at two or more outputs of the flow manifold. The apparatus also includes two or more splitters 504. The input of each splitter is provided by a corresponding output of the manifold, and each splitter is a splitter as described above.

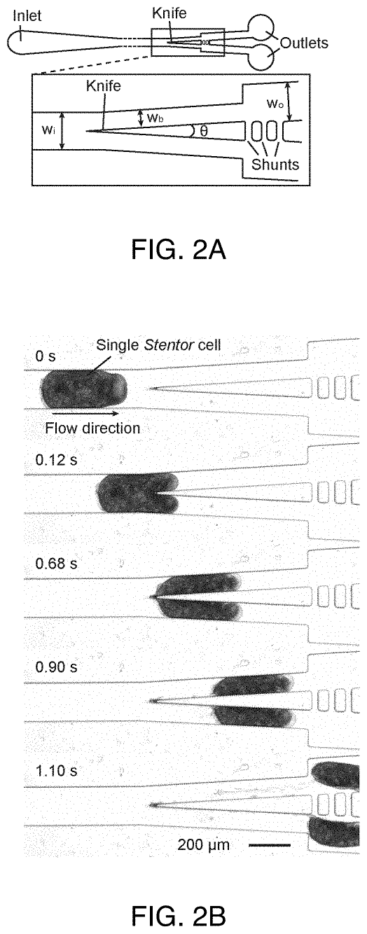

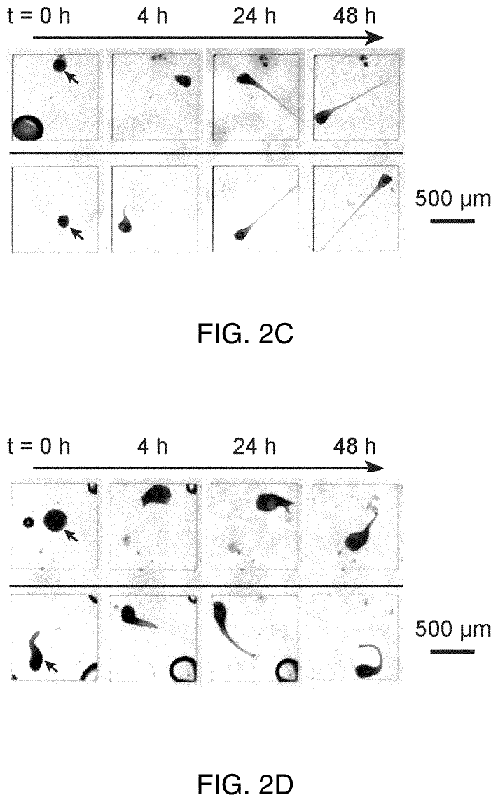

Sections B and C and the preceding description all relate to equal split ratios. Although that is often desired, it is important to note that flow splitters can be designed to provide controllable and unequal split ratios. The outlet split ratio of the apparatus is determined primarily by the relative flow rates in the fluidic outlet channels. To first order, if the two outlet channels have a flow rate split of F1:F2, then the sample split (by volume) will be in that same ratio. In the experiments of section B a 50:50 split ratio was desired, and shunts as shown on FIG. 2A were employed to symmetrize the splitters of that work. Thus the examples of FIGS. 1D-E relate to deliberately making the splitter asymmetric to provide a controlled and unequal splitting ratio.

The relative flow rates in the fluidic outlet channels can be determined by a lateral position of the blade within the fluidic inlet channel configured to make the Y-junction asymmetric, as in the example of FIG. 1D. Here outlet channel 104 is narrower than outlet channel 106, thereby creating the above-described asymmetry.

The relative flow rates in the fluidic outlet channels can be determined by an asymmetric downstream fluidic configuration of the fluidic outlet channels, as in the example schematically shown on FIG. 1E. Here the outlet channel formed by channel sections 104a and 104b differs from outlet channel 106, so the flow rates in the two channels will be different even though the outlet channel widths are equal at the Y-junction.

In some embodiments, the Y-junction is disposed in a plane and the blade is formed by a vertical edge of the Y-junction that is perpendicular to the plane of the Y-junction. Other blade configurations than this are expected to also provide biological sample splitting as described herein. Another possible geometrical variation is in the lateral shape of the splitter. For example, the curved output channels of the configuration of FIG. 1F.

### B) Single Cell Splitting Experimental Demonstration

### B1) Introduction

Wound repair is an essential biological process for maintaining homeostasis and, ultimately, for survival. Compared with tissue-level wound healing, how individual cells heal wounds and regenerate damaged or lost cellular structures is less understood. Nevertheless, there is increasing recognition that single cells—such as muscle cells and neurons—are capable of wound repair.

Understanding how single cells repair themselves is important for determining fundamental cellular functions, and eventually for revealing how wound-induced diseases such as muscular dystrophies develop.

Thus far, studies of single-cell wound response have been performed in a few model organisms. In particular, studies performed in Xenopus oocytes elegantly leveraged the unique advantages of the oocyte system, including the large size and the ability to create and visualize a wound in the focal plane of the microscope, to shed light on cellular components participating in wound healing and to reveal their dynamic interactions through live cell imaging. Nevertheless, as with any model system, Xenopus oocytes are better suited to some types of experiments than to others. For example, oocytes are transcriptionally inactive and are preloaded with large stockpiles of mRNA; they are thus not a good system for investigating transcriptional response to wounding. To interfere with protein production in Xenopus oocytes, morpholino oligonucleotides are injected to inhibit mRNA translation to prevent protein production. This method is expensive due to the high cost of synthesizing morpholino oligos. The need to inject cells one at a time also limits the throughput of the approach. In addition, because oocytes are loaded with maternally derived protein, protein depletion may be incomplete even when translation is entirely blocked. It is also a potential concern that the morpholino injection process inevitably wounds the cells. By the time one performs wound-healing assay the cells may have already undergone a wound-healing cycle and may therefore be in an unusually primed state. As such, there is a need for a complementary system to Xenopus oocytes that would be more amenable to high-throughput gene knockdown approaches and transcriptional profiling analysis. Ideally, such system should be compatible with simple and cost-effective methods for altering gene expression, such as RNAi by feeding, to facilitate the study of a large number of cells without wounding the cells during the gene alteration process.

Here, we use Stentor coeruleus as a model organism for single-cell wound repair studies because it satisfies such requirement. Stentor is a single-celled ciliate protozoan that is up to 1 mm long. They exist as single cells and are regularly wounded under physiological conditions (e.g., attacks by predators) and are known to be capable of recovering robustly from drastic wounds and regenerating from cell fragments as small as 1/27th of the original cell size. Stentor was a popular organism in the early 1900s but was never developed as a molecular model system partly because culturing in large quantities was difficult. With the advent of low-input next-generation sequencing tools, it has become feasible to develop Stentor as a model organism. The genome of Stentor has recently been published. We have also demonstrated the utility of RNAi to knock down gene expression, by feeding Stentor bacteria containing an expression plasmid encoding dsRNA that targets genes of interest. Stentor thus offers a substantial technical advantage over Xenopus oocytes for high-throughput knockdown studies.

To take full advantage of high-throughput gene knockdown, a method is required for wounding cells in a concomitantly high-throughput manner. Rapid, high-throughput wounding is also critical for ensuring sufficient time resolution in subsequent observations, because wound repair is intrinsically a dynamic process. In Stentor, regeneration is resolved into a series of morphological steps, each of which takes about 1 h. Any study that aims to probe the mechanism and time evolution of wound repair will require a method that can generate a large number of cells wounded on a time scale that is short compared with the time scale of repair, so that all cells are relatively synchronized in their stage of the process. Unfortunately, the traditional wounding method based on the manual manipulation of glass needles is too slow to meet this need. It takes˜3 min to wound one cell depending on the skill of the experimenter. Obtaining 100 cells would take 5 h, during which much healing and regeneration would have already occurred. Additionally, wounding groups of cells to the same degree is challenging, because controlling wound size with manual cutting is difficult. It is thus impossible to perform time-course experiments involving analysis such as RNA sequencing, which typically requires hundreds of cells.

An alternative method using laser ablation has been applied to introduce wounds in other cell types. Laser wounding is directly compatible with imaging-based analysis because it can be performed through the same microscope that is used for subsequent imaging. The throughput is relatively low, however, because the laser spot has to be repositioned and refocused to wound each new cell. The ideal wound-healing assay for our purposes should introduce wounds at a throughput much higher than that allowed by traditional manual dissection methods.

In this work, we aim to solve the above limitations by using a microfluidic guillotine device to automate the cutting of Stentor cells in a continuous-flow manner. Instead of moving a sharp object (e.g., a knife) against a relatively immobile cell, we flow the cell into a knife with a fixed position inside a microfluidic channel. Our design has two key advantages: (i) The confinement of the cell in the microchannel allows simple positioning of a cell to the knife, and (ii) it facilitates the processing of a continuous stream of cells in a flow-through manner, because cut cells can be flushed out of the channel easily. In the first demonstration of principle, we focus on the bisection of cells. We monitor the shape of the cell during the cutting process at different applied flow conditions and measure the subsequent cell viability. We believe that our microfluidic platform will lay the foundation critical for using Stentor to understand how single cells heal wounds and regenerate.

### B2) Results and Discussion

### B2a) Design and Validation of the Microfluidic Guillotine Device.

FIG. 2A shows a scheme of the microfluidic guillotine device. The knife was a simple triangular blade made in polydimethylsiloxane (PDMS). A cell injected into the microchannel was cut at the knife, and the two halves of the cut cell (“fragments”) flowed into the two outlet channels. We found that the PDMS knife was sufficiently stiff and effective to cut Stentor, although PDMS is relatively soft (Young's modulus˜500 kPa). In all our experiments we did not observe any deformation in PDMS itself. Although we have not measured the Young's modulus of Stentor, we expect its value to be close to that of unicellular Dictyostelium(˜1-8 kPa), about 100 times smaller than that of PDMS. To facilitate the efficient cutting of Stentor we used channels with dimensions smaller than the size of a cell (Table 1). This confinement ensured the cells were cut at the knife and prevented them from bypassing the knife and flowing into one of the outlets without being cut. To ensure cells were cut into approximately equal halves we included fluidic shunts immediately downstream of the knife. The shunts helped to equalize the pressure in the two outlets and to avoid disturbance to the cutting process arising from changes in the fluidic resistance at the outlet.

TABLE 1
Experimental parameters and range of values tested in this work

| Parameter | Description | Values | |
|---|---|---|---|
| h | Channel height | 100 | μm |
| wᵢ | Inlet width | 200 | μm |
| w_{b} | Outlet width at the blade | 95 | μm |
| wₒ | Outlet width | 190 | μm |
| θ | Blade angle | 6°, 13°, 40°, 72°, 122° | |
| Q | Single phase flow rate | 0.13-21.5 | mL/h |
| Q_{d} | Disperse phase flow rate | 1.2 | mL/h |
| Q_{c} | Continuous phase flow rate | 1.84 | mL/h |

FIG. 2B shows images of the cell during the cutting process at a flow rate of Q=0.36 mL/h. The cutting process involves three basic steps. (i) The cell comes into contact with the knife tip. (ii) The cell extends into the two branches downstream, but its rear end remains attached at the knife tip. (iii) As the cell continues to extend downstream, the rear end of the cell at the knife tip decreases in thickness and stretches into a thin thread, which eventually snaps off and the cell is split into two fragments that flow downstream separately.

To validate our microguillotine, FIG. 2C shows images of the regeneration of two cell fragments at different times (at time t=0, 4, 24, and 48 h after the cut) after a single cell was cut by our device. FIG. 2D shows a similar set of images from a different cell cut manually using a glass needle. Both cells cut by our device and by hand were able to survive and regenerate normal morphology within 24-48 h. The typical Stentor cell cycle length is 3 d, and we observed that cells cut with either method survived for at least 5 d, at which point they had often undergone cell division to form new cells. These observations show that the cells had recovered important features indicating viability.

### B2b) Effect of Applied Viscous Stress on Cell Deformation and Survival.

FIGS. 2A-C show the effect of the applied flow rate at a fixed blade angle of 6°. We have chosen to use this blade angle because we were able to obtain the highest cell survival rate at ˜97% compared with larger blade angles. Based on the cell extension length and survival data, we separated the flow into two regimes: regime I (v≤v_{c}), and regime II (v>v_{c}), where v_{c}˜1.5 cm/s. For each case, the cells were suspended in a methylcellulose solution at a concentration of 0.2% wt/vol or 0.5% wt/vol.

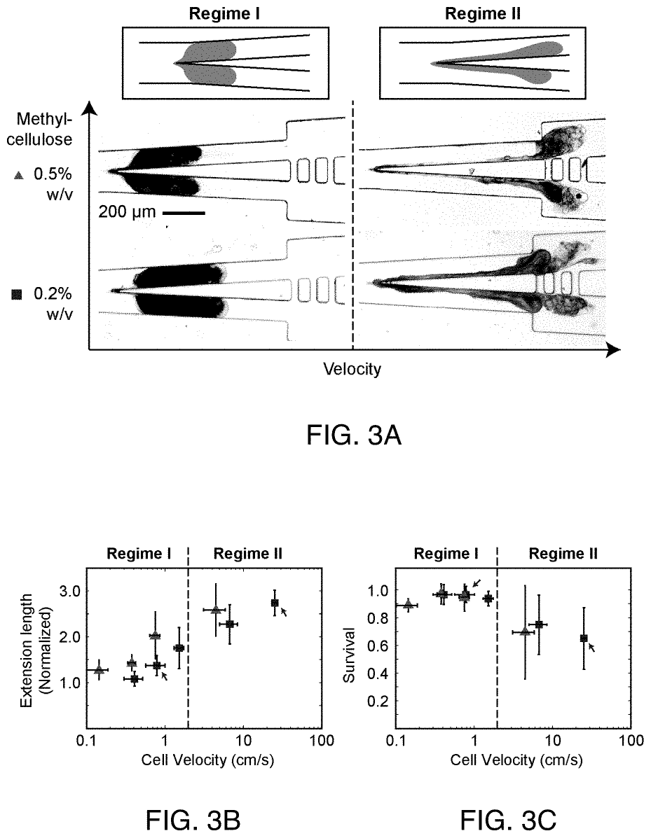

In regime I, the viscous stress was low. The cells spanned the whole width of the channel before, during, and at the completion of the cut (FIG. 3A). The cell did not undergo large deformation. The maximum extension length was small, εₘₐₓ<about 2 (FIG. 3B). In this work, the extension lengths reported were normalized to the length of the major axis of the uncut cell before it contacted the knife (Materials and Methods). In addition, the cells always split at the knife tip into two cell fragments that were approximately equal in size. The difference in the size of the two fragments was, on average, 10-16% of the mean size of the two cell fragments. Although we were not always able to differentiate the membrane from the cell content using our imaging setup, the membrane seemed to rupture only at the knife tip at the end of the cutting process in most of the cuts. The cell content typically stayed inside the cell during the entire process. The cell survival rate was above 90% (FIG. 3C).

In regime II, the applied flow rate—and thus the viscous stress experienced by the cells—increased. We observed changes in the morphology of the cell distinct from that in regime I during the cutting process. Whereas the cells spanned the whole width of the channel before the cut, they became highly stretched during the cut and did not span the whole width of the channel before the cut completed (FIG. 3A). The membrane rupture was no longer confined to the rear end of the cell at the knife tip. The membrane often tore at multiple locations downstream of the knife and led to spilling of cell content. The extension length increased with velocity, reaching εₘₐₓ˜3 (FIG. 3B). Because we could not easily identify the cell membrane, the increased extension length reported here was contributed by both an increase in membrane deformation and an increase in cell content spilled out. As velocity increased the cells also tended to split into two or more fragments at random locations downstream of the knife tip. The sizes of the fragments were, therefore, less uniform than those cut in regime I. The corresponding cell survival rate also decreased from close to 100% to ˜60% (FIG. 3C).

In our design there are two possible sources of stress that can act together to cut the cell. The first source arises from the cell pushed normal against the knife by the fluids. This stress could lead to a cutting mechanism where the knife tip penetrates the cell membrane, followed by the splitting of cell content into two halves. The second source is a viscous stress provided by the flow around the cell. This stress tends to lead to the tearing of the membrane. Depending on the detailed local hydrodynamics and mechanical properties of the cell, the rupture could occur at the tip of the blade or other parts of the cell.

In regime I, it was unlikely that the knife had penetrated the cell membrane upon initial contact. Instead, the cells were often observed to wrap around the knife blade without being punctured initially. As the cell continued to flow downstream the membrane at its rear end stretched and eventually pinched off at the knife tip. The pinch-off was driven primarily by viscous stress close to the knife tip. The degree of membrane rupture seemed to be relatively small and confined to the rear end of the cell only. In regime II, the pressure exerted on the cell by the knife at the flow rates applied could approach that needed to penetrate the membrane. It thus became possible that the knife had punctured the membrane as the cell first contacted the knife, although an improved imaging setup will be necessary to verify this process. Nevertheless, in this regime the high viscous stress experienced by the cell led to an increased extension of the cell and caused membrane ruptures at multiple locations downstream of the knife tip. The predominant way that cells were cut arose from these ruptures, which led to the splitting of the cell into fragments of different sizes along with extensive spilling of the cytoplasm.

B2c) Transition from Regime I to Regime II.

The identification of the threshold velocity has immediate practical value in guiding the choice of channel geometry and experimental conditions. Because cell survival decreased rapidly in regime II, the maximum velocity to cut the cells to achieve a high throughput of cutting while maintaining cell viability is at the threshold velocity when regime I transitions to regime II.

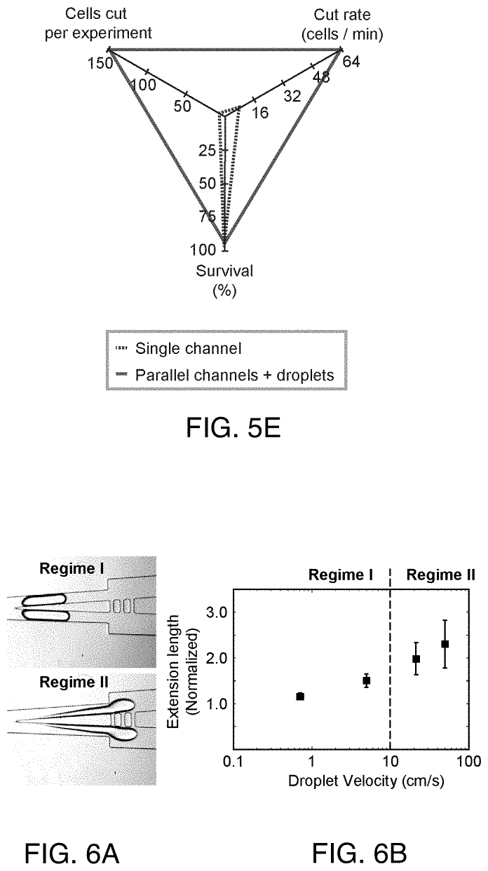

To probe why the transition occurred at a velocity of v_{c}˜1.5 cm/s would require further characterization of the mechanical properties of Stentor. The properties of the cell membrane and cell content are highly nonlinear, anisotropic, and heterogeneous and are an active area of research. Interestingly, we found that the morphology of the cell during the cut was similar to that of a shear-thinning viscoelastic drop, which also exhibited a transition from regime I to regime II when we increased the velocity of flow above a critical velocity (FIGS. 6A-B). Such similarity suggests that the critical velocity for the cutting of the cell in our device could perhaps be modeled without having to consider the entirety of the complex internal structure and rheology of the cell.

### B2d) the Relationship Between Cell Deformation and Survival.

FIGS. 3B-C show that, in general, cell extension or deformation was inversely related to survival rate. The increased spread of data in regime II reflects that the location where the cell split, the number and the size of the cell fragments, and the corresponding wound sizes were less controlled than that in regime I. The relationship between cell extension and survival here is qualitatively consistent with previous work that reported that large deformation increased the strain on the surface of the cell, and thus the likelihood of cell lysis and cell death.

There are key differences between the cells studied previously (e.g., human prostate primary adenoma cancer cells and mouse myoblasts) and Stentor, however. For example, when the cell membrane expanded beyond˜50%, the viability of human prostate primary adenoma cancer cells was reported to decrease rapidly as evidenced by cell lysis. However, most of the Stentor cells survived in regime I even though their normalized extension length increased to εₘₐₓ˜2, corresponding to up to a doubling of its apparent surface area. This capability was in part due to the ability of Stentor to deform: We and others have observed that Stentor can contract to 20-25% of its extended length in milliseconds when stimulated mechanically. Left undisturbed, Stentor returns to its extended state in a few seconds. In addition, Stentor survived after being split into two fragments, during which the membrane must have opened (and the cell must, therefore, have been “lysed”). Indeed, Stentor have been observed to be capable of recouping the cytoplasm from membrane ruptures and surviving afterward, as well as surviving grafting experiments in which two cut cells were fused together at the site of the cuts. These results, along with those presented in this paper, indicate that membrane rupture alone did not lead to immediate cell death in Stentor.

Nonetheless, cells undergoing large deformation in regime II also tended to have increased membrane ruptures that led to increased spillage of the cell content. We believe that the increased loss of cell content eventually led to decreased cell survival here. To probe the degree of membrane rupture, we used a small, negatively charged fluorophore, bis-(1,3-dibutylbarbituric acid)trimethine oxonol [DiBAC4(3)], which is typically membrane-impermeable. It can enter depolarized cells and bind to intracellular proteins or membranes to exhibit increased fluorescence intensity.

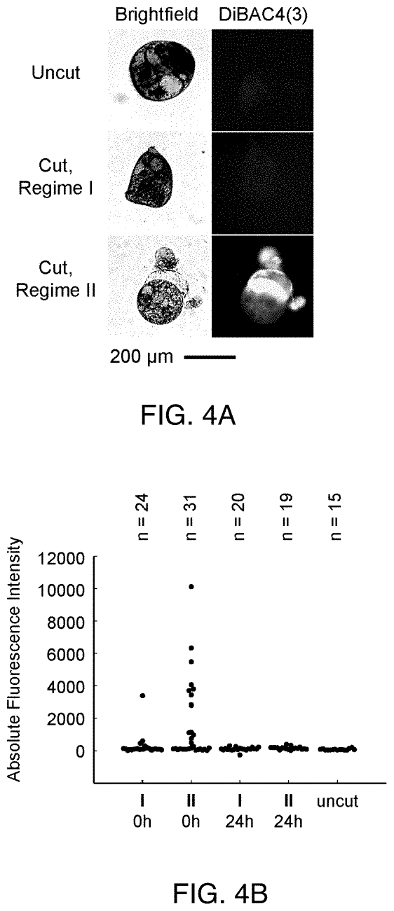

FIG. 4A shows that when the cell was intact, DiBAC4(3) could not permeate the membrane and was barely fluorescent. When the cell was cut, its membrane ruptured. Stentor, having an approximate resting membrane potential of −50 mV, became depolarized. At the same time, the intracellular proteins became exposed to the media containing DiBAC4(3). The fluorescence intensity of DiBAC4(3) increased from that in intact cells.

In general, fluorescence intensity should increase with increasing wound size because more DiBAC4(3) could enter the cell and interact with intracellular proteins. Indeed, the fluorescence intensity of DiBAC4(3) in cells cut in regime I was not significantly different from that in uncut cells. In contrast, the fluorescence intensity in cells cut in regime II was, on average, 20 times higher than in uncut cells. The location of the fluorescence also correlated with the part of the cell where the membrane seemed to be missing (FIG. 4A). These observations confirm that the wound size was smaller when the cells were cut under low viscous stress than when they were cut under high viscous stress, in agreement with the measured cell extension and survival data in FIGS. 3B-C.

We note the spread of the fluorescence data were larger in cells cut in regime II than in cells cut in regime I. For example, there were cells that exhibited fluorescence up to six times higher than the mean in the same experiment. They corresponded to severely wounded cells with visibly disrupted membranes. These cells were unlikely to survive, partly supported by the fact that dead cell fragments, which have lost their membrane integrity, were even more fluorescent than the severely wounded cells. There were also cells that exhibited low fluorescence (<1,000 in absolute fluorescence intensity, FIG. 4B) similar to those of cells cut in regime I. These cells were likely to survive. We counted the number of cells that had low levels of fluorescence (n=20) versus those that were highly fluorescent (n=11), and the percentage of cells with low fluorescence was about 64%. This value corresponded well with the 60% survival rate in regime II (FIG. 3C).

Furthermore, we performed the same assay on the cut cells after 24 h. We first identified cells that were alive (Materials and Methods) and then measured the fluorescence of these cells. We found that all cells that survived, whether cut in regime I or II, had low levels of fluorescence. This result indicates that all cells that survived the cut must have also healed the membrane ruptures in 24 h.

### B2e) Self-Cleaning of the Knife and Increasing Cutting Throughput.

After cutting, we observed that cell residues were sometimes left at the knife tip (FIG. 5A). This observation was similar to that reported in previous studies on the splitting of droplets past an obstacle (e.g., a pillar) in a channel, where a small residual drop was left upstream of the obstacle under certain flow conditions. The cell residue left behind was significantly smaller than the size of the cell (<10% of uncut cell size). This loss of cell mass did not seem to impair the healing and regeneration of the cell fragments. After about 5-10 cuts, however, the knife became blunted due to the accumulation of cell residues, which also started to clog the channels. The cutting of subsequent cells became difficult: Cells would either squeeze through the clogged channel and lose much of their cytoplasm, become stuck at the knife, thereby clogging the channel further, or go down one outlet without being cut.

To generate a sufficient number of cells (>100) for studies such as RNA sequencing, a method to clean the knife was necessary. We found that the encapsulation of Stentor in aqueous drops before cutting facilitated the self-cleaning of the knife. Surface tension between the aqueous media and the oil facilitated the retaining of cell fragments within the drop, thereby preventing residues from accumulating on the knife (FIG. 5B). FIG. 5A shows that the knife was still clean after 10 cuts when cells were encapsulated in drops, whereas significant cell residues accumulated after 10 cuts when cells were not in drops. Significantly, we note that the ability to encapsulate and cut cells in droplets makes our method directly compatible with library preparation of cells within droplets for single-cell RNA sequencing and other droplet-based next-generation sequencing approaches.

In previous sections we identified a threshold velocity above which cell viability decreased rapidly at the transition of regime I and II. This threshold velocity sets the fastest rate for cutting a single cell, whether encapsulated inside a drop or not. At the concentration of cells used in our experiments we achieved a maximum cutting throughput of about eight cells per minute in a single microguillotine. To increase the throughput further, we designed a device having eight parallel droplet generators each followed by a knife downstream (FIGS. 5C-E). The inset of FIG. 5C is micrographs showing the cut cell inside a droplet collected at the outlet of the device. The drops can be merged subsequently and the cell fragments can be collected and imaged out of the drops. Using this parallel device we achieved a cutting throughput of 64 cells per minute, >200 times faster than that when cutting cells by hand (FIG. 5E). Because the time scale for regeneration is about 10 h, this throughput is sufficient to generate enough cell fragments that are relatively synchronized in their stage of healing and regeneration for subsequent RNA sequencing experiments. The mean survival rate in cells cut by this parallel device was 94% (measured across three separate experiments), similar to the maximum survival rate for cells cut by a single knife.

### B3) Conclusions

We have reported a demonstration of a microfluidic guillotine device for the high-throughput cutting of Stentor. Examining the local cutting dynamics reveals two regimes under which cells are cut. In regime I, the low viscous stress causes the cell to wrap around the knife and cell splitting occurs at the cell's rear end, where the membrane pinches off at the knife tip. Wound size is well-controlled, and cell survival is close to 100%. In regime II, the high viscous stress causes the cell to deform extensively. The membrane often ruptures at random locations, generating multiple cell fragments with variable wound sizes. Cell viability decreases rapidly. The threshold velocity at which regime I transitions to II governs the maximum cutting throughput while maintaining high cell viability. Parallelizing the microguillotines increases the throughput to 64 cells per minute, two orders of magnitude faster than that by manual cutting. Our method is therefore capable of preparing hundreds of cells in a relatively synchronized stage of their wound repair, which is intrinsically a dynamic and time-dependent process. The identification of the two regimes of cutting with and without extensive membrane rupture provides opportunities to probe wound healing and regeneration separately. The ability to cut cells inside droplets further allows one to exploit existing droplet microfluidics techniques for next-generation sequencing analysis.

Real-time imaging of the membrane during the cut will allow for the identification of the position and the size of membrane ruptures. The measurement of the mechanical properties of Stentor, such as membrane tension, will further enable the prediction of cell response during the cutting process and will guide the design and the further development of the microguillotine for increased control of wounding.

The development of standardized tools and assays was critical for progress in the field of tissue-level wound healing, because they allowed different perturbations to be compared across samples with similar wound sizes in similar stages of the repair process. Our microfluidic platform presents an important step toward such a standardized assay and is expected to lay the foundation for understanding how single cells repair themselves. Furthermore, it should be possible to adapt our microguillotine design to other cell types. For cells of the size of a few microns or bigger, the soft lithographic method we had used to fabricate the microchannel and the knife can still be used. The material we had used was effective for cutting soft cells such as Stentor. For cells with increased stiffness, polymers (e.g., polycarbonate) with a higher elastic modulus than PDMS can be used.

### B4) Materials and Methods

### B4a) Analysis of Stentor Morphology During Cutting.

To characterize the cutting process in the microfluidic guillotine device we used a high-speed camera (Phantom v7.3) mounted on an inverted microscope with a 5×objective to record videos of the process.

To extract the extension length of the cells we used ImageJ. We defined the extension length to be the length of the cell fragment measured from the tip of the knife to the edge of the cell fragment that was the furthest away from the knife tip. We recorded the maximum extension length of each cell fragment in the frame immediately before the cut was complete, defined as the time when the two cell fragments detached from each other. The maximum extension length was then normalized to the length of the major axis of the uncut Stentor before it contacted the knife. In this paper, we report the normalized maximum extension length as εₘₐₓ.

B4b) Measurement of Cell Survival Rate after the Cut.

To quantify the number of cells that survived the cut we collected the cell fragments from the device into a Petri dish containing pasteurized spring water (PSW). We monitored the morphology of the cells manually under a bright-field stereomicroscope. Because the membrane of Stentor disintegrates quickly after death, we classify a cell to be alive and to have regenerated successfully if (i) it has restored membrane integrity demonstrated by beating cilia and (ii) it is either actively swimming or attached to a surface in its namesake trumpet-like shape 24 h after the cut, a typical duration of time for Stentor to complete regeneration. A grid was drawn on the bottom of the Petri dish to facilitate counting of live cells.

To quantify the survival rate, we measured the number of live cells 24 h after the cut, N_{post-cut}. The survival rate is defined as N_{post-cut}/2·N_{pre-cut} where N_{pre-cut} is the number of cells injected into the device, counted manually from the videos of the cutting process. As a benchmark, we compared cuts using our device to cuts performed by hand, the conventional wounding method in previous regeneration studies. To cut cells by hand, we heated a glass capillary over a flame and stretched it into a thin needle (tip diameter˜30 μm), which was then cooled to room temperature before cutting through a cell that was immobilized in a 2% wt/vol methylcellulose solution. This solution was sufficiently viscous to reduce cell movement during cutting. After cutting, we added PSW to dilute the methylcellulose solution for subsequent monitoring of regeneration.

### B5) Further Details

FIGS. 6A-B show the effect of flow rate on splitting of a shear-thinning viscoelastic droplet. The drop was methylcellulose solution (2% wt/vol), and the continuous phase was HFE-7500 containing EA surfactant (2% wt/wt). The infinite rate viscosity of the drop solution was measured 900 cP. FIG. 6A shows snapshots of the drop in regime I and II. The definition of the two regimes was the same as that in section B for a cell. FIG. 6B show extension length of the drop as a function of the velocity of the drop. We note that similar transition in droplet shape occurred with increasing flow rate in a Newtonian droplet of water or a glycerol solution (20% wt/wt), except that in regime II the rear end of the drop often broke into smaller drops instead of forming a long thread hanging at the knife.

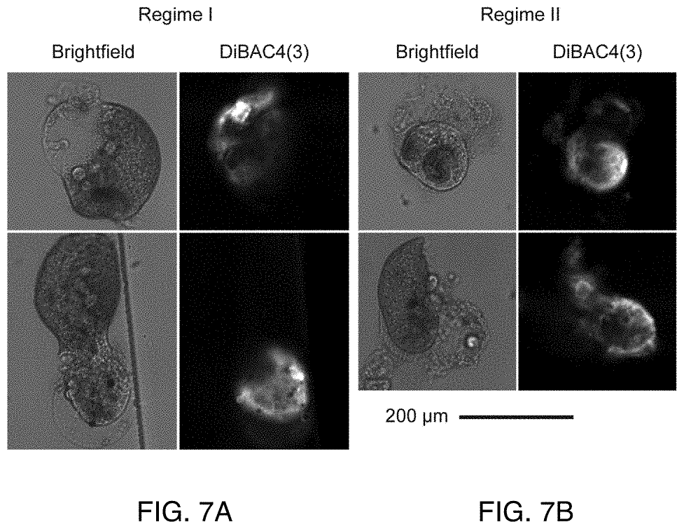

FIGS. 7A-B compare wound size in regimes I and II. More specifically, wound size within 1 min after cutting the cell in (FIG. 7A) regime I at cell velocity=0.70 cm/s and (FIG. 7B) regime II at cell velocity=8.38 cm/s. To perform these experiments, we incubated the cells in a DiBAC4(3) solution in PSW (5 μM) for 5 min before cutting the cells. The cells were then cut in the microfluidic guillotine directly in this solution. We stopped the flow after the cell was cut and imaged the cut cells within 1 min of the cut in the same channel that had a large imaging chamber downstream of the knife. Compared with the assay performed in FIGS. 4A-B, incubating cells in DiBAC4(3) before they were cut allowed the DiBAC4(3) molecules to diffuse into cell immediately after the cells were cut. The resulting DiBAC4(3) fluorescence could better reflect the extent of membrane rupture during the cutting process. We note, however, that the absolute fluorescence intensity distribution depends also on the local diffusivity of the DiBAC4(3) molecules, as well as the local concentration of intracellular proteins that DiBAC4(3) associates with. It is thus difficult to quantify the actual size of the membrane rupture during the cut based on the absolute fluorescence intensity distribution. Nevertheless, in regime I, if the knife had penetrated the cell membrane and split the cell that way we would expect to see a large wound that would expose half of the cytoplasm. DiBAC4(3) could then diffuse into the cell easily. The resulting DiBAC4(3) fluorescence should then spread throughout the majority of the cut cell. As shown in the images, however, we observed that the size of the wound was relatively small and localized. In some cases, we did not observe any fluorescence. In addition, during the cutting process, we did not observe any spilling of the cytoplasm until almost the entire cell length had entered the two outlet channels. In contrast, for cells cut in regime II, the fluorescence spread over almost the entire cut cell. Such results are consistent with the extended degree of membrane rupture in regime II.

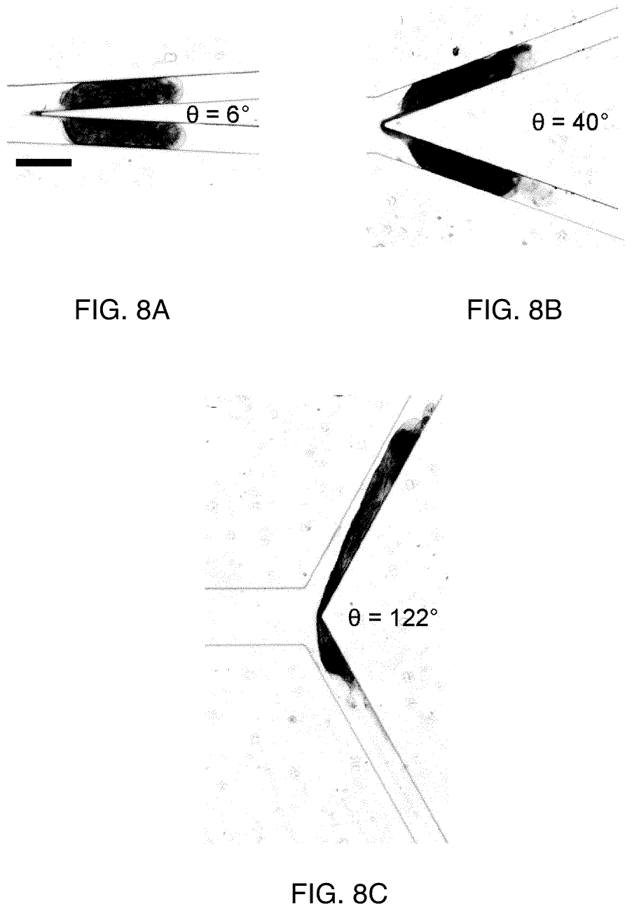

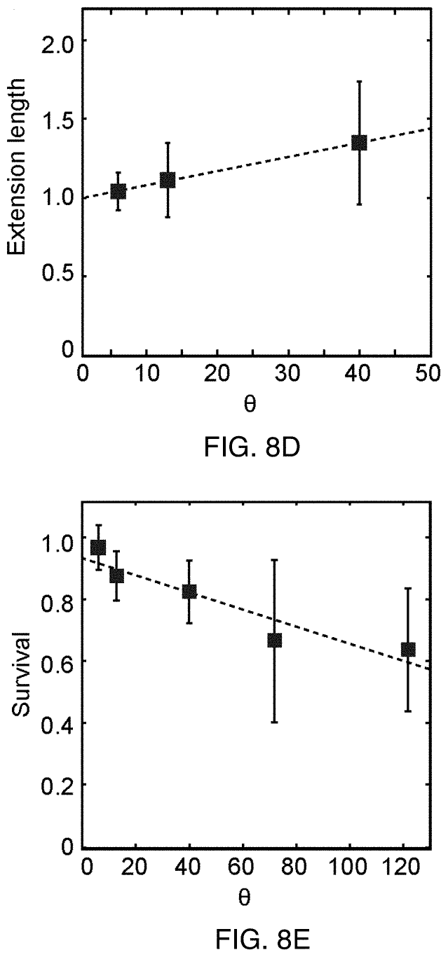

FIGS. 8A-C show exemplary images of some blade angles used in this work. FIG. 8D show extension length vs. blade angle. FIG. 8E shows survival rate vs. blade angle.

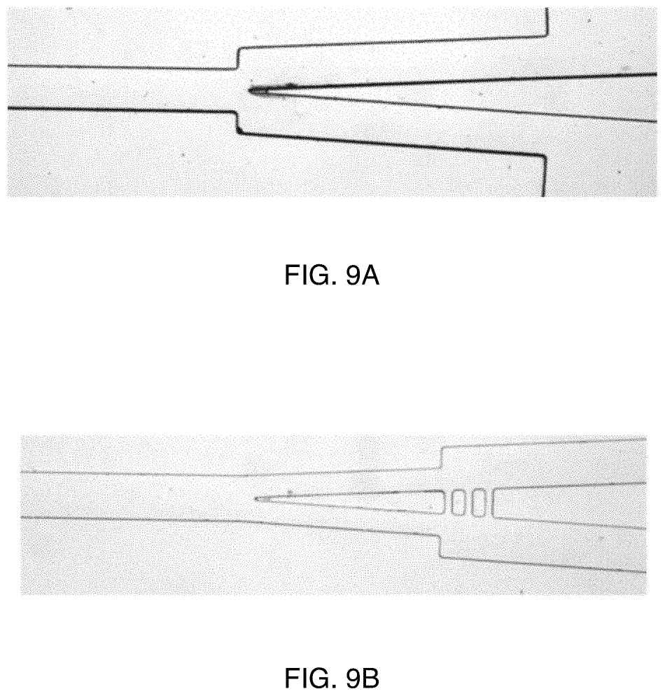

In our work on Stentor we have tested both w_{b}˜½ wᵢ (FIG. 9B and previous description) and w_{b}˜wᵢ (FIG. 9A).

Both geometries can be used to cut materials in half. Increasing w_{b} with respect to wᵢ allows the device to be operated at a higher flowrate before transitioning from regime I to regime II. It is expected that the configuration of FIG. 9A will be preferable for soft materials like cells, as the configuration of FIG. 9B requires a low flowrate which may be inconvenient. In contrast, the configuration of FIG. 9B is expected to be preferable for stiff materials like tissue, as the configuration of FIG. 9A will require an inconveniently high flowrate.

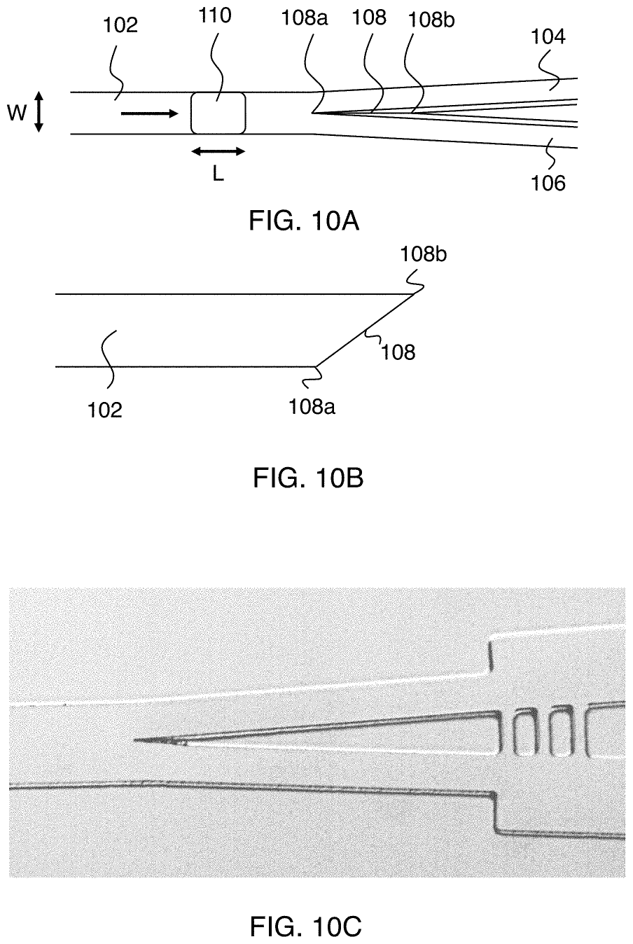

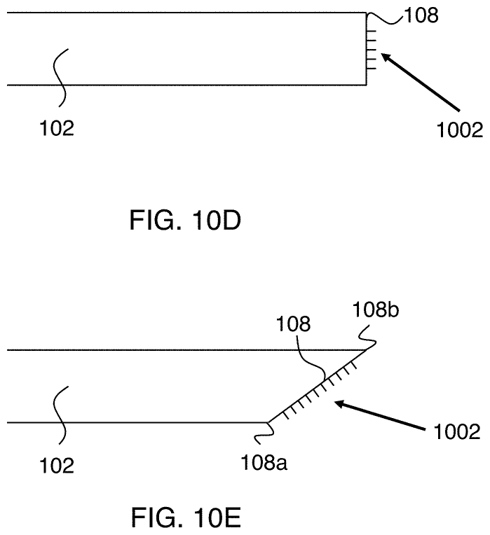

FIGS. 10A-E show further variations of blade shape. In the preceding examples, the blade formed by the split of the Y-junction was vertical within the microfluidic channels. However, it is also possible for the blade to be vertically angled within the microfluidic channels, as shown in the top view of FIG. 10A and corresponding side view FIG. 10B. Here the side view of FIG. 10B is along the midline of FIG. 10A, and this midline is not shown on FIG. 10A because it would interfere with the structural features of that figure. In this example, blade 108 formed by the Y-junction split is vertically angled such that bottom point 108a and top point 108b of the blade are offset from each other as shown. Such a vertically angled Y-junction blade can be formed by appropriately angling the side walls of channels 104 and 106. The resulting angled blade is expected to cut better than a vertical blade, by analogy with the normal cutting behavior of knives. FIG. 10C is an top view image of a fabricated device having such a vertically angled Y-junction blade.

FIGS. 10D-E show variations of the blade design where micro-roughness 1002 is deliberately provided at or near the edge of the blade. Here roughness 1002 is schematically shown near the blade edge rather than being exactly on it. Since the idealized edge of a blade is a line with no thickness, such roughness is typically present immediately adjacent the blade edge, as opposed to being on the blade edge itself. FIG. 10D and FIG. 10E relate to vertical and angled blades, respectively. Again, this is motivated by analogy to the cutting behavior of knives, where it is known that a polished knife edge cuts poorly compared to a knife edge having an appropriate level of micro-roughness at or near its edge. In this application, such roughness helps create friction on the side of the biological material during the cut, which increases the shear stress of the material and thus decreases the normal force required to cut the material. Such micro-roughness can be created in various ways, such as: 1) incorporating suitable micro-features into the design of the device, 2) adjusting the UV exposure time, bake time, or development time of the photoresist from which the device is patterned, or 3) creating the blade out of a naturally grittier material.

### C) Multi-Cell Splitting Experimental Demonstration

### C1) Introduction

During the development of multicellular organisms, tissues self-organize into the complex architectures essential for proper function. Even with minimal external instructions, cells proliferate, diverge into distinct cell types, and spatially self-organize into complex structures and patterns. Such self-organized structures are radically different from most human-made structures, because they are not assembled from preexisting parts that are physically linked according to a defined Cartesian blueprint. Rather, these structures emerge through a series of genetically programmed sequential events. To test and better develop our understanding of the principles governing multicellular self-organization, it would be powerful to design synthetic genetic programs that could direct the formation of custom multicellular structures.

Extensive studies of natural developmental programs have implicated many genes that control cell-cell signaling and cell morphology. Despite their molecular diversity, a common theme in these developmental systems is the use of cell-cell signaling interactions to conditionally induce morphological responses. Thus, we explored whether simple synthetic circuits in which morphological changes are driven by cell-cell signaling interactions could suffice to generate self-organizing multicellular structures.

C2) Engineering Interacting Cells that Self-Organize into a Two-Layer Structure

We first focused on engineering two cell types that, when mixed, might communicate with and activate one another to induce the formation of a self-organized structure. We engineered a sender cell that expresses the synNotch ligand CD19 and blue fluorescent protein (BFP) (cell A) and a receiver cell that expresses the cognate anti-CD19 synNotch receptor and its response element (cell B). To induce cell sorting as an output of synNotch signaling, we placed the E-cadherin (Ecad) and GFP genes under the control of the synNotch-responsive promoter in the receiver cells (cell B). The circuit is represented by the following scheme:

[cell A:CD19]→[cell B:αCD19synNotch→Ecadhi+GFP]

As predicted, when cocultured with A-type sender cells, B-type receiver cells were activated to express Ecad and GFP (C-type cell phenotype). Subsequently, the green (GFP)C-type cells self-sorted to form a tight inner core, resulting in a well-defined two-layer structure.

### C3) Synthetic Assembly is Robust, Reversible, and Self-Repairing

To see how reproducibly the synthetic cell-cell signaling program could drive three-layer formation, we followed 28 independent replicate cocultures starting with 200 A-type cells and 40 B-type cells. In most wells (57%), cells formed a single three-layer spheroid. In other wells, we observed “twin” multicore three-layer spheroids (21%) or multiple (separate) three-layer spheroids in the same well (11%). Thus, the overall three-layer architecture of cells was robustly generated in ˜90% of the cultures. Three-layer formation was robust to variation in the initial number or ratio of starting cells. Only when we used a low number of starting A-type cells did we begin to see formation of two-layer structures, because all the A-type cells were converted to low E-cadherin expressing cells (i.e., the number of A cells was limiting).

In many cases, natural self-organized tissues have an ability to regenerate after injury. To test how this three-layer structure would respond to injury, we cut the structure into two fragments with a microfluidic guillotine system. Immediately after cleavage, the GFP-positive core cells were exposed to the surface, but within 24 hours, the green core cells were re-enveloped by the red layer, regenerating the spherical three-layer structure). To further test the reversibility of the self-assembled three-layer structure, we added the synNotch inhibitor DAPT to preformed structures. The layered structure and distinct cell types were totally disrupted within 3 days of treatment; hence, this dynamically maintained structure can be disassembled by turning off cell-cell signaling.

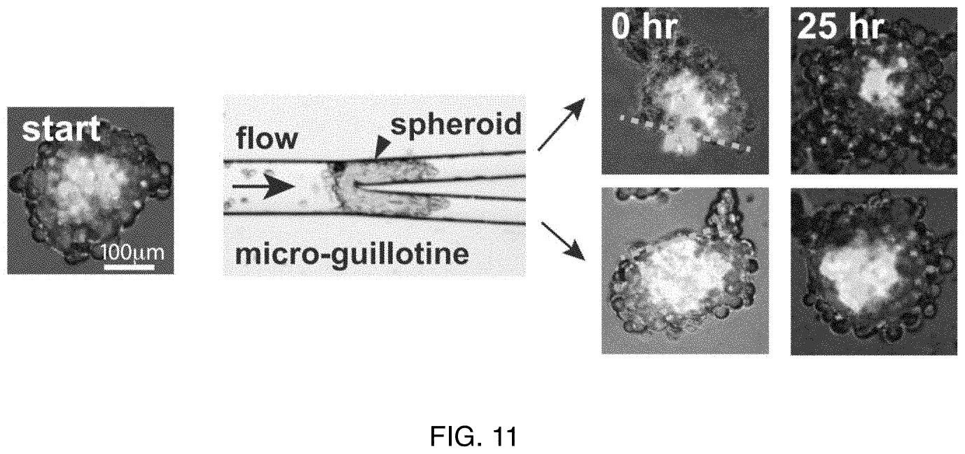

FIG. 11 shows self-repair of a cleaved three-layer structure. The preformed spheroid was cleaved using a microfluidic guillotine, and the two resulting fragments were observed for 25 hours. The frames at 0 hours show the two fragments, with a dotted line indicating the cleavage plane that exposes the internal core of the spheroid.

Images at 25 hours show self-repair of the spherical three-layer structure.

For bisecting spheroids, we adjusted the channel geometry and cutting velocity. The dimensions of the channel were chosen based on two criteria. 1) The channel should be sufficiently small to confine the spheroid within the channel so that the centroid of the spheroid was aligned to the knife for reproducible bisection into two equal halves. 2) The confinement should be just sufficient to avoid excessive shear on the spheroid at the channel wall. We tested different channel cross-section size (130 μm×50 μm, 150 μm×50 μm and 200 μm×50 μm (width×height)) and found 150 μm×50 μm led to sufficient confinement of the spheroid in the channel while reducing the damage to the spheroid by shear. We injected the spheroids at a flow rate of 148 cm/s. At flow rates lower than this value, the organoids were not able to consistently enter the channel. We note that this flow rate was about 200 times higher than that required to cut Stentor coeruleus (as in section B above), likely due to the increased stiffness of the spheroids compared with Stentor. Confinement of the organoid in the channel is important for it being cut in half. Without proper confinement, it is cut into two pieces of unequal size.

The forces acting on the tissue in our device geometry will be the same as the forces acting on the cell. We showed in FIGS. 6A-B that a simple shear thinning viscoelastic droplet of water has a similar regime I to II transition as cells. Thus the regime I to II transition is likely a property of any viscoelastic material that we cut in our geometry. Even though both cells and tissues are viscoelastic materials, there are differences between them which may lead to differences in the transition from regime I to regime II. For example, cells are wrapped in a membrane which must be ruptured before the cell can be cut, while tissues are not wrapped in a membrane. Because the regime I to II transition appears to be a property of our device geometry for viscoelastic materials, we expect that tissues will have a regime I to II transition but that the transition may look different than in single cells. Specifically, we expect viscous forces to cause the tissue to split into multiple uneven fragments in regime II, while in regime I the tissue will be cut into primarily two even fragments.

1. A method for splitting a biological sample, the method comprising:
splitting a biological sample in a fluidic apparatus;
wherein the fluidic apparatus includes a fluidic input channel and two fluidic output channels, and wherein the inlet channel and the outlet channels meet at a Y-junction where the inlet channel is in fluid communication with the two outlet channels;
wherein an interior tip of the Y-junction is a blade configured to split the biological sample from the fluidic inlet channel into substantially two parts while fluid flows through the Y-junction, and to deliver the two parts separately to the two fluidic outlet channels;
wherein the biological sample includes one or more biological structures selected from the group consisting of: cells, organoids, tissues, and multi-cell structures; and
wherein the blade is configured to split one or more biological cells of the one or more biological structures in operation.

2. The method of claim 1, wherein a flow rate of fluid through the apparatus is selected such that the biological sample is locally cut by the blade to provide the two parts.

3. The method of claim 1, wherein the biological sample is a single cell.

4. The method of claim 1, wherein the biological sample is a multi-cell sample.

5. The method of claim 1, wherein an outlet split ratio of the fluidic apparatus is between 60:40 and 40:60.

6. The method of claim 1, wherein an angle of the blade is 40 degrees or less.

7. The method of claim 1, wherein the fluidic inlet channel is sized to control a position of the biological sample while still permitting fluid flow and movement of the biological sample through the fluidic apparatus.

8. The method of claim 1, wherein the fluidic inlet channel is sized such that the biological sample in the fluidic inlet channel forms a plug of length L in the fluidic inlet channel, wherein W is a largest lateral dimension of the fluidic inlet channel, and wherein L is 1.1 W or more.

9. The method of claim 1, wherein the fluidic outlet channels expand in cross-section at the Y-junction, and wherein a total width of the two fluidic outlet channels after this expansion is greater than or equal to a width of the fluidic inlet channel.

10. The method of claim 1, wherein the Y-junction is disposed in a plane and wherein the blade is formed by a vertical edge of the Y-junction that is perpendicular to the plane.

11. The method of claim 1, wherein the Y-junction is disposed in a plane and wherein the blade is formed by a non-vertical edge of the Y-junction that is oblique to the plane.

12. The method of claim 1, wherein the blade has a predetermined micro-roughness at or in proximity to a cutting edge of the blade.

13. The method of claim 1, wherein a Young's modulus of the blade is at least 10× greater than a Young's modulus of the biological sample.

14. The method of claim 1, wherein an outlet split ratio of the fluidic apparatus is determined primarily by relative flow rates in the fluidic outlet channels.

15. The method of claim 14, wherein the relative flow rates in the fluidic outlet channels are determined by a lateral position of the blade within the fluidic inlet channel configured to make the Y-junction asymmetric.

16. The method of claim 14, wherein the relative flow rates in the fluidic outlet channels are determined by an asymmetric downstream fluidic configuration of the fluidic outlet channels.

17. A method for multiply dividing a biological sample, the method comprising:
performing the method of claim 1 in a fluidic configuration including two or more stages of fluidic splitters, wherein each outlet of a fluidic splitter of a prior stage is connected to an inlet of a fluidic splitter of a subsequent stage;
wherein each fluidic splitter includes a fluidic input channel and two fluidic output channels, and wherein the inlet channel and the outlet channels meet at a Y-junction where the inlet channel is in fluid communication with the two outlet channels;
wherein an interior tip of the Y-junction of each fluidic splitter is a blade configured to split the biological sample from the fluidic inlet channel into substantially two parts while fluid flows through the Y-junction, and to deliver the two parts separately to the two fluidic outlet channels.

18. The method of claim 1, further comprising:
encapsulating the biological sample in a droplet to facilitate self-cleaning of the blade in operation.
